(19) United States
(12) Patent Application Publication
(10) Pub. No.: US 2020/0139920 A1
(43) Pub. Date: May 7, 2020

(54) KNITTED SEAT TRIM COVER WITH INTEGRAL AIRBAG POCKET

(71) Applicant: GM Global Technology Operations LLC, Detroit, MI (US)

(72) Inventors: Daniel W. BOOTH, Troy, MI (US); Paul W. ALEXANDER, Ypsilanti, MI (US); Nancy L. JOHNSON, Northville, MI (US); Heidi H. MCADOO-WILSON, Tecumseh (CA); Scott D. THOMAS, Novi, MI (US); Anthony L. SMITH, Troy, MI (US); Janet C. ROBINCHECK, Sterling Heights, MI (US)

(73) Assignee: GM Global Technology Operations LLC, Detroit, MI (US)

(21) Appl. No.: 16/178,006

(22) Filed: Nov. 1, 2018

(51) Int. Cl. B60R 21/2165; B60N 2/58; B60R 21/207; B60R 21/231; B60R 21/261; B60R 21/2338; B60R 21/235

(52) U.S. Cl. CPC B60R 21/2165; B60N 2/58; B60R 21/207; B60R 21/23138; B60R 2021/21506; B60R 21/2338; B60R 21/235; B60R 21/231; B60N 2002/5808; B60R 21/261

(57) ABSTRACT

A knitted seat trim cover for use on a vehicle seat equipped with an airbag assembly includes a first knitted panel with a first edge and a second knitted panel with a second edge. The first edge is positioned adjacent the second edge to define an airbag deployment zone. The seat trim cover also includes a pocket panel integrally knit with the first knitted panel and the second knitted panel. The pocket panel defines an airbag pocket configured to hold at least a portion of the airbag assembly.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to knitted seat trim covers with integral airbag pockets.

Vehicle seats often include airbag assemblies positioned inside the vehicle seat and/or under trim cover panels of the seat. In such positions, the airbag assemblies can be hidden from view until the airbag cushions of the airbag assemblies deploy. A deployed airbag cushion can deploy from the vehicle seat to a position between an occupant and interior components of the vehicle.

Seat trim covers for vehicle seats can be made of knitted fabrics. Such knitted seat trim covers are positioned over the internal structure of the seat to provide an aesthetically pleasing and comfortable seating surface. The knitted seat trim covers can be positioned over seats that include airbag assemblies. Such knitted seat trim covers maintain the aesthetically pleasing and comfortable seating surface while additionally being compatible with operation of the airbag assemblies.

### SUMMARY

In one example in accordance with the present disclosure, a knitted seat trim cover for use on a vehicle seat equipped with an airbag assembly includes a first knitted panel including a first edge and a second knitted panel including a second edge. The first edge is positioned adjacent the second edge to define an airbag deployment zone. The seat trim cover also includes a pocket panel integrally knit with the first knitted panel and the second knitted panel. The pocket panel defines an airbag pocket configured to hold at least a portion of the airbag assembly.

In one aspect, the airbag pocket is configured to hold an airbag cushion and the first edge and the second edge separate to permit the airbag cushion to move from the airbag pocket through the airbag deployment zone between the first edge and the second edge.

In another aspect, the first edge and the second edge are releasably connected to each other at the airbag deployment zone.

In another aspect, the first edge and the second edge are connected with one or more knitted loops of connecting yarn material at the airbag deployment zone. The one or more loops of connecting yarn material are configured to break to permit the first edge and the second edge to separate to allow an inflated airbag to pass between the first edge and the second edge.

In another aspect, the first panel and the second panel are different than the connecting yarn material in material type of knit density.

In another aspect, the first edge and the second edge are connected to one another with a temporary thread. The temporary thread is configured to maintain the first edge adjacent to the second edge while the knitted seat trim cover is installed on a vehicle seat and to dissolve after the knitted seat trim cover is installed to permit the first edge to separate from the second edge when the airbag cushion moves through the airbag deployment zone.

In another aspect, the pocket panel includes a first knitted deployment guide configured to guide the airbag cushion in a predetermined direction through the airbag deployment zone.

In another aspect, the first knitted deployment guide is knitted of one of a heat-activated yarn material, a material stiffer than a material of the first panel, and a knitted pattern more dense than a knitted pattern of the first panel.

In another aspect, the pocket panel includes a second knitted deployment guide positioned on a side of the airbag deployment zone opposite to the first knitted deployment guide.

In another aspect, the first panel includes a knitted deployment guide configured to guide the airbag cushion in a predetermined direction when the airbag cushion inflates to a deployed position, and the knitted deployment guide is knitted of at least one of a heat-activated yarn material, a material stiffer than a material of the first panel, and a knitted pattern more dense than a knitted pattern of the first panel.

In another aspect, the knitted seat trim cover also includes a knitted airbag cushion positioned inside the airbag pocket.

In another aspect, the airbag cushion includes a knitted chute that defines an inflation pathway to direct inflation gas in a predetermined direction. The knitted chute integrally knitted into the airbag cushion.

In another aspect, the airbag cushion includes a knitted plenum portion. The knitted plenum portion is configured to distribute inflation gas in the airbag cushion to cause the airbag cushion to inflate in a predetermined direction.

In another aspect, the airbag cushion or the pocket panel includes one or more tethers integrally knit with the seat trim cover. The one or more tethers are configured to guide deployment of the airbag cushion in a predetermined direction.

In another aspect, the airbag cushion is knitted into the pocket panel.

In another aspect, the airbag cushion is knit with a knitted structure that causes the airbag cushion to roll or fold until the airbag cushion is inflated.

In another aspect, the airbag cushion includes a first arm and a second arm that project outward from an inflation portion of the airbag cushion. The first arm is configured to interlock with the second arm to maintain the airbag cushion in a predetermined position.

In another example in accordance with the present disclosure, a knitted seat trim cover for use on a vehicle seat includes a cover panel configured to cover a seating surface of the vehicle seat and an airbag pocket integrally knit with the cover panel. The airbag pocket includes an expansion portion configured to elongate or expand. The seat trim cover also includes an airbag cushion positioned inside the airbag pocket. The airbag cushion is configured to expand the airbag pocket when the airbag cushion inflates to a deployed position.

In one aspect, the airbag pocket includes a deployment edge configured upon deployment to define an opening through which the airbag cushion inflates to the deployed position.

In another aspect, the airbag cushion is positioned behind an occupant-facing surface of the cover panel in both a stowed position and the deployed position. The airbag cushion causes the occupant-facing surface to expand toward an occupant when the airbag cushion inflates to the deployed position.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle seat including an example shaped knitted seat trim cover of the present disclosure;

FIG. 2 is a side view of the vehicle seat of FIG. 1 showing an airbag cushion in a deployed position;

FIG. 3 is a sectional view of a vehicle seat showing an example shaped knitted seat trim cover with an airbag pocket;

FIG. 4 is a perspective sectional view of another example shaped knitted seat trim cover with an airbag pocket;

FIG. 5 is a perspective sectional view of another example shaped knitted seat trim cover with an airbag pocket;

FIG. 6 is a perspective sectional view of another example shaped knitted seat trim cover with an airbag pocket;

FIG. 7A is a side view of a vehicle seat showing an example deployment zone of a shaped knitted seat trim cover in which the deployment zone wraps around the airbag assembly;

FIGS. 7B-7D are illustrations of other example deployment zones that are used on the knitted seat trim cover of FIG. 7A;

FIG. 8 is a sectional illustration of a shaped knitted seat trim cover that includes an example deployment guide;

FIG. 9 is a sectional illustration of a shaped knitted seat trim cover that includes another example deployment guide;

FIGS. 10A and 10B are sectional illustrations of example shaped knitted seat trim covers that include knitted tethers;

FIG. 11 is a perspective sectional view of an example knitted airbag cushion that includes a knitted chute and plenum portion;

FIG. 12 is a perspective sectional view of an example knitted airbag cushion that includes a plenum portion and an inflation portion;

FIG. 13 is an illustration of another example knitted airbag cushion that includes a knitted chute;

FIG. 14A is an illustration of a knitted airbag cushion with a knitted structure that predisposes the airbag cushion to fold into a stowed position;

FIG. 14B is an illustration of a rolled knitted material for use with the knitted airbag cushion of FIG. 14A;

FIG. 14C is an illustration of a folding knitted material for use with the knitted airbag cushion of FIG. 14A;

FIG. 15 is an illustration of the knitted airbag cushion of FIG. 14A in the deployed position;

FIG. 16 is an illustration of an example knitted airbag cushion having a complex shape;

FIG. 17 is an illustration of interlocking arms that can be included on the knitted airbag cushions of the present disclosure;

FIG. 18 is a perspective view of a vehicle seat including another example shaped knitted seat trim cover;

FIG. 19 is an illustration of an example knitted airbag pocket that can be included on the knitted seat trim cover of FIG. 17;

FIG. 20 is a sectional illustration of the vehicle seat of FIG. 17 showing an airbag cushion positioned behind a cover panel of the knitted seat trim cover;

FIG. 21 is a sectional illustration of the vehicle seat of FIG. 17 showing another example airbag cushion positioned behind the cover panel of the knitted seat trim cover; and

FIG. 22 is a sectional view of an example knitted seat trim cover with an integral airbag pocket and airbag cushion showing aspects of the airbag assembly for connection to a vehicle seat.

In the drawings, reference numbers may be reused to identify similar and/or identical elements.

### DETAILED DESCRIPTION

The seat trim covers of the present disclosure are constructed using a shaped knitted fabric. The use of a shaped knitted fabric, as opposed to other types of fabrics, allows three-dimensional structures and shapes to be integrally knitted into the seat trim cover. Since such structures, layers and shapes are integrally knit into the seat trim cover, secondary processing, such as sewing, is reduced and/or minimized. The seat trim covers, in some examples, are knit using different weaving orientations/patterns and/or different types of yarns or yarns of different materials. As such, the material properties of different localized areas of the seat trim cover are different to assist in the functional and aesthetic needs of the seat trim covers.

In one example, a knitted seat trim cover includes a first panel that includes a first edge. The knitted seat trim cover also includes a second panel that includes a second edge. The first edge and the second edge are positioned adjacent to one another to define an airbag deployment zone. The knitted seat trim cover also includes a pocket panel defining an airbag pocket. The airbag pocket is configured to hold at least a portion of an airbag assembly and to direct the airbag cushion out of the seat upon airbag deployment. The first panel, the second panel and the pocket panel are integrally knitted together.

In one example, the airbag pocket holds an airbag cushion of the airbag assembly. The airbag pocket restrains the airbag cushion during deployment. The airbag cushion moves from the airbag pocket through the airbag deployment zone when the airbag cushion inflates during deployment. The first edge and the second edge are knitted together from a suitable material such that the airbag cushion breaks, tears or otherwise separates the first edge from the second edge when the airbag cushion inflates to the deployed position.

The present disclosure describes use of knitted seat trim covers for a vehicle seat. The knitted trim covers of the present disclosure, however, can be used in other applications. The knitted trim covers can also be used, for example, in other interior trim components, seats in other modes of transportation, in furniture, in clothing, in architectural applications, and in other consumer products.

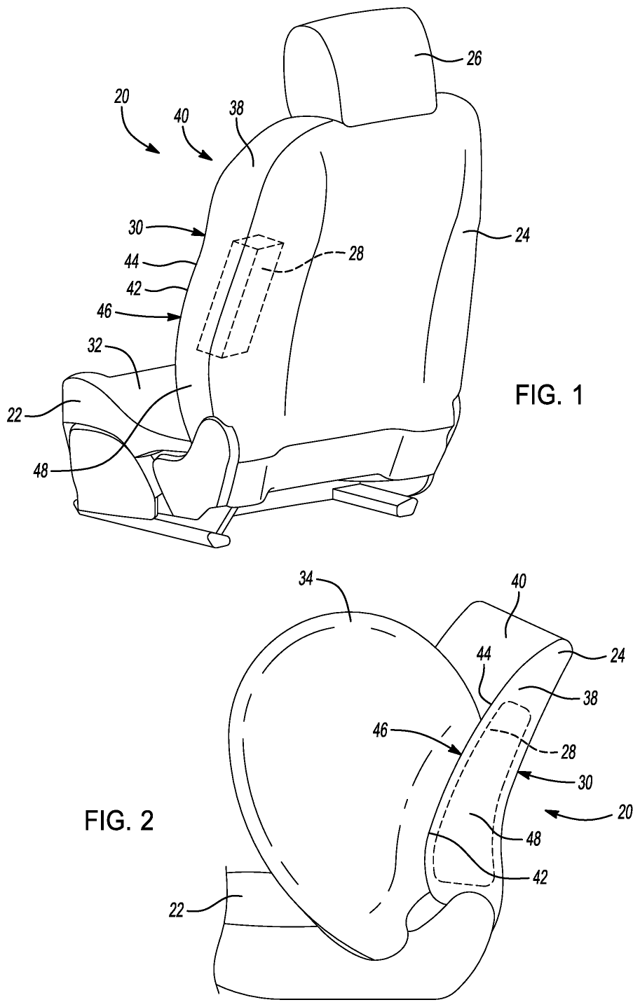

Referring now to FIG. 1, a vehicle seat 20 includes a seat bottom 22, a seat back 24 and a head restraint 26. The vehicle seat 20 can include any suitable support structure. In the example shown, the vehicle seat 20 has an internal support structure covered with one or more layers of foam material. A seat trim cover 30 is installed over the internal support structure and the foam material to result in an aesthetically pleasing, comfortable and durable seating surface. An occupant-facing surface 32 of the seat trim cover 30 faces outward on the vehicle seat 20 and is the side of the seat trim cover 30 on which an occupant is seated.

Traditional seat trim covers are often constructed of several separate pieces of material (e.g., leather, vinyl, textile) that are sewn together to create a seat cover with the general shape of the vehicle seat 20. The seat trim covers 30 of the present disclosure are created of a knitted material. The seat trim covers 30 are formed using one or more yarns that are knit into interlocking looping structures including various courses and wales. The knitting process used to create the seat trim covers 30 can create knitted structures having various shapes and formations such that the seat trim cover 30 can be knitted into the general shape of the vehicle seat 20 without the need to knit or otherwise create separate pieces of material and subsequently join the pieces of material together. The knitted seat trim covers 30 can be integrally knitted with one or more panels of material to form a unitary trim cover.

Any suitable knitting process can be used to create the integrally knitted seat trim covers 30. In one example, the integrally knitted seat trim covers 30 are knit using a flat bed knitting machine to create the shaped or three dimensional (3D) knitted structures described herein. The seat trim covers 30 can be knit using weft knitting processes, warp knitting processes, circular knitting processes, flat knitting processes and the like. The knitting process can be selected to best match the desired geometry of the seat trim application. Such knitting processes can be automated, for example, using knitting machines. Such machines permit integrally knitted structures, such as the knitted seat trim covers 30 of the present disclosure, to include multiple types of yarn within a single integrally knitted structure. Such yarns can be made of different constructions and different materials to provide the functionality and characteristics necessary for the knitted seat trim cover to perform as needed. This functionality and characteristics may vary between different regions on the knitted seat trim cover. As will be further described, such flexibility of the knitting processes permits the knitted seat trim covers 30 to have structural and functional improvements over traditional seat trim covers.

The knitting processes also can be used to create three dimensional (3D) structures in the knitted seat trim covers 30 of the present disclosure. The integrally knit seat trim covers, in some examples, include shapes, structures or other formations that can project, curve or extend from the planar surfaces of the trim cover. Since such shapes, structures or other formations are integrally knit into the seat trim covers 30, secondary processing that would otherwise be required to connect such shapes, structures or other formations is reduced or minimized.

Referring back to FIG. 1, the vehicle seat 20 also includes an airbag assembly 28 that is positioned, in this example, inside the seat back 24. The airbag assembly 28, as shown, is a side impact airbag assembly that deploys an airbag cushion 34 (see FIG. 2) to a deployed position between an occupant and internal components of the vehicle. As can be appreciated, the principles and structure of the present disclosure can be applied to airbag assemblies 28 positioned in other locations in the vehicle seat 20 and/or in other locations in the vehicle.

As shown in FIGS. 1-3, the knitted seat trim cover 30 includes a first panel 38 and a second panel 40. The first panel 38 and the second panel 40 are portions of the integrally knitted seat trim cover 30. The first panel 38 and the second panel 40 are positioned adjacent to each other along a first edge 42 and a second edge 44, respectively. The first edge 42 and the second edge 44 define a deployment zone 46 through which the airbag cushion 34 deploys when the airbag cushion 34 is inflated. As shown, the first edge 42 and the second edge 44 appear as a seam in the knitted seat trim cover 30. The knitted seat trim cover 30, however, is integrally knitted such that the first panel 38 and the second panel 40 are created during a common knitting process. In other examples, the knitted seat trim cover 30 can be knit such that the first panel 38 and the second panel 40 do not have a visible marking or have a minimized visible marking at the first edge 42 and/or the second edge 44. In such examples, the first edge 42, the second edge 44 and/or the deployment zone 46 are not readily visible to an observer.

As shown in FIG. 2, the airbag cushion 34 can deploy through the deployment zone 46 to a deployed position. When the airbag cushion 34 moves to the deployed position, the first edge 42 and the second edge 44 separate from one another to form an opening in the knitted seat trim cover 30. In this example, the airbag cushion 34 deploys from a side portion 48 of the vehicle seat 20 in a forward direction. As such, the airbag cushion 34 is positioned between an occupant and the side structures and/or door structures of the vehicle. In other examples, the airbag cushion 34 can be positioned in other orientations or in other locations relative to the vehicle seat 20 when the airbag cushion 34 moves to the deployed position.

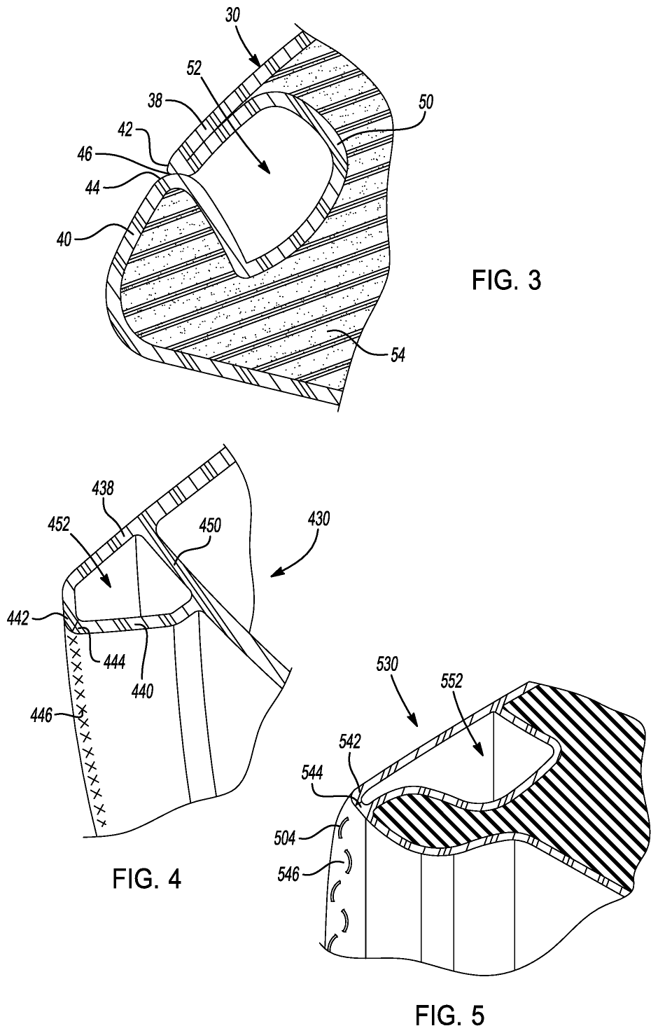

Referring now to FIG. 3, a sectional view of a portion of the knitted seat trim cover 30 and the vehicle seat 20 is shown. The seat trim cover 30 includes the first panel 38, the second panel 40 and a pocket panel 50. As previously described, the first panel 38 includes the first edge 42 and the second panel 40 includes the second edge 44. The pocket panel 50 is a portion of the seat trim cover 30 that extends between the first edge 42 and the second edge 44. As shown, the pocket panel 50 defines an airbag pocket 52. The airbag pocket 52 is a cavity that holds one or more elements of the airbag assembly 28 (FIGS. 1, 2).

The vehicle seat 20 includes a foam support 54 that has contours or other shapes as necessary to support an occupant. The knitted seat trim cover 30 has a complimentary shape that permits the knitted seat trim cover 30 to be installed over the foam supports 54. In the example shown, the first panel 38 and the second panel 40 are installed over the outer surfaces of the foam support 54 and the pocket panel 50 is inserted into a space in the foam support 54. In this manner, the knitted seat trim cover 30 is supported by the foam support 54 and/or other internal supports of the vehicle seat 20.

As previously described, the first edge 42 and the second edge 44, in one example, are positioned adjacent to one another during the knitting process. The first edge 42 and the second edge 44 separate from one another when the airbag cushion 34 moves through the deployment zone 46 when the airbag cushion 34 inflates to the deployed position. As such, the first edge 42 and the second edge 44 are releasably connected to one another. The first edge 42 and the second edge 44 can be releasably connected to one another using any suitable structure.

In one example, the knitted seat trim cover 30 is knitted using a heat-activated yarn at the deployment zone 46. The heat-activated yarn can be any suitable bonding or fusible yarn such as yarns made with threads of low melt polyamides, copolyamides, low melt polyesters, co-polyesters and the like. The heat-activated yarns made with threads of such materials undergo a change in their mechanical properties after the heat-activated yarn is heated. For example, after the knitted seat trim cover 30 is heated at or above a predetermined melting temperature for a predetermined heating time, the heat-activated yarns melt and bond with surrounding yarns and/or threads to create a relatively more rigid structure than before heating. The portion of the knitted seat trim cover 30 at the deployment zone 46, in one example, is knitted with a heat-activated yarn that becomes brittle or creates a weakened attachment. In other examples, the seat trim cover 30 includes a knit structure of the heat-activated yarn that creates a brittle point. When the airbag cushion 34 inflates to the deployed position, the airbag cushion 34 contacts the brittle or weakened attachment deployment zone 46 and can break or tear the knitted seat trim cover 30 at the deployment zone 46 to permit the first edge 42 to separate from the second edge 44. After breaking or tearing the knitted seat trim cover 30, the airbag cushion 34 can fully inflate to the deployed position.

FIG. 4 shows another example knitted seat trim cover 430. The example knitted seat trim cover 430 has some different structures from that previously described. In this example, the first panel 438, the second panel 440 and the pocket panel 450 define the airbag pocket 452. The airbag pocket 452 holds at least a portion of the airbag assembly 28 (FIG. 1) including the airbag cushion 34. The first panel 438, the second panel 440 and the pocket panel 450 are integrally knit together to form the unitary seat trim cover 430. The pocket panel 450 bridges between the first panel 438 and the second panel 440 and is spaced apart from the deployment zone 446.

The first edge 442 and the second edge 444, in this example, are positioned at the ends of the first panel 438 and the second panel 440, respectively. Since the first panel 438 and the second panel 440 are portions of the integrally knit seat trim cover 430, the first edge 442 and the second edge 444 may not be visible to an observer. Instead, the first panel 438 and the second panel 440 may appear as a single continuous panel of knitted material.

The deployment zone 446, in the example shown, includes a portion (as denoted by the “X's” in FIG. 4) that is knit with a material having different material properties than the surrounding portions of the seat trim cover 430. For example, the deployment zone 446 can be knit with a yarn having a lower tensile strength than the surrounding portions of the seat trim cover 430. With this characteristic, the deployment zone 446 is structured to break or tear when the deployment zone 446 is contacted by the airbag cushion 34 when the airbag cushion 34 inflates. When the deployment zone 446 breaks or tears, the first edge 442 separates from the second edge 444 and permits the airbag cushion 34 to inflate to the deployed position.

In one example, the deployment zone 46, 446 is made of yarn or thread having a tensile strength of 1/10th or less of the tensile strength of surrounding yarns. In another example, the deployment zone 46, 446 is made of yarn or thread having a tensile strength of ¼th or less of the tensile strength of surrounding yarns. In another example, the deployment zone 46, 446 is made of yarn or thread having a tensile strength of ⅓rd or less of the tensile strength of surrounding yarns. In still another example, the deployment zone 46, 446 is made of yarn or thread having a tensile strength of ½ or less of the tensile strength of surrounding yarns. In still other examples, the yarn of the deployment zone 46, 446 may have other relative strengths when compared to the surrounding yarns of the seat trim cover 430. In yet one more example, the deployment zone 46, 446 is made of similar material that is knit or woven in a less dense or less thick fabric than the surrounding panels 38, 40, 50, 438, 440, 450 which makes the deployment zone 46, 446 weaker than these surrounding panels.

To create a deployment zone 46, 446 that releases, breaks or tears, one or more courses or wales of the knitted structure of the seat trim cover 30, 430 at the deployment zone 46, 446 is knit with a yarn than is different from the surrounding courses or wales. In other examples, the knitted structure of the deployment zone 46, 446 can be changed from the knitted structure at the surrounding portions of the seat trim cover 30, 430. The deployment zone 46, 446, for example, can include a greater quantity of float stitches than surrounding knitted structures. In still other examples, a lower denier yarn can be used at the deployment zone 46, 446. In yet other examples, the geometry of the knitted structure can change to make the knitted fabric weaker in the deployment zone 46, 446.

The weakened structure of the deployment zone 46, 446 can also be varied along its perimeter. In one example, the weakened structure of the deployment zone 46, 446 has a continuous structure. In such examples, the brittle material, the lower tensile strength yarn, the lower denier yarn or the otherwise weakened knitted structure has a constant property along its length or perimeter. In other examples, the weakened knitted structure is intermittently knitted into the seat trim cover 30, 430 along the length or perimeter of the deployment zone 46, 446. In the intermittent examples, the force required to break or tear the deployment zone 46, 446 can be designed to be at or above a predetermined deployment force threshold by varying the distance between the intermittent weakened knitted structures. It is desirable that the deployment zone 46, 446 only break or tear at or above the predetermined deployment force threshold so that the seat trim cover 30, 430 does not inadvertently break or tear during normal use of the vehicle seat 20.

It is also desirable that the deployment zone 46, 446 does not inadvertently break or tear during assembly of the seat trim cover 30, 430 to the vehicle seat 20. When the seat trim cover 30, 430 is installed, the seat trim cover 30, 430 can be pulled over the foam supports 54 and/or the underlying structure of the vehicle seat 20. Zippers, clips or other attachment features can be used to secure the seat trim cover 30, 430 in position. Such installation forces can inadvertently cause the weakened portion of the seat trim cover 30, 430 to break or tear at the deployment zone 46, 446. To prevent such inadvertent failure, the seat trim cover 30, 430 can include a temporary connector.

In one example, as shown in FIG. 5, a temporary thread 504 or yarn is knit into the seat trim cover 530 at the deployment zone 546. The temporary thread 504 is of sufficient strength to connect the first edge 542 to the second edge 544 to prevent the first edge 542 from prematurely separating from the second edge 544. The temporary thread 504 is removed from the seat trim cover 530 after the seat trim cover 530 is installed onto the vehicle seat 20 during production. Once the temporary thread 504 is removed, the deployment zone 546 includes the weakened structure as previously described to permit the airbag cushion 34 installed in the airbag pocket 552 to break through the deployment zone 546 when the airbag cushion 34 inflates to the deployed position.

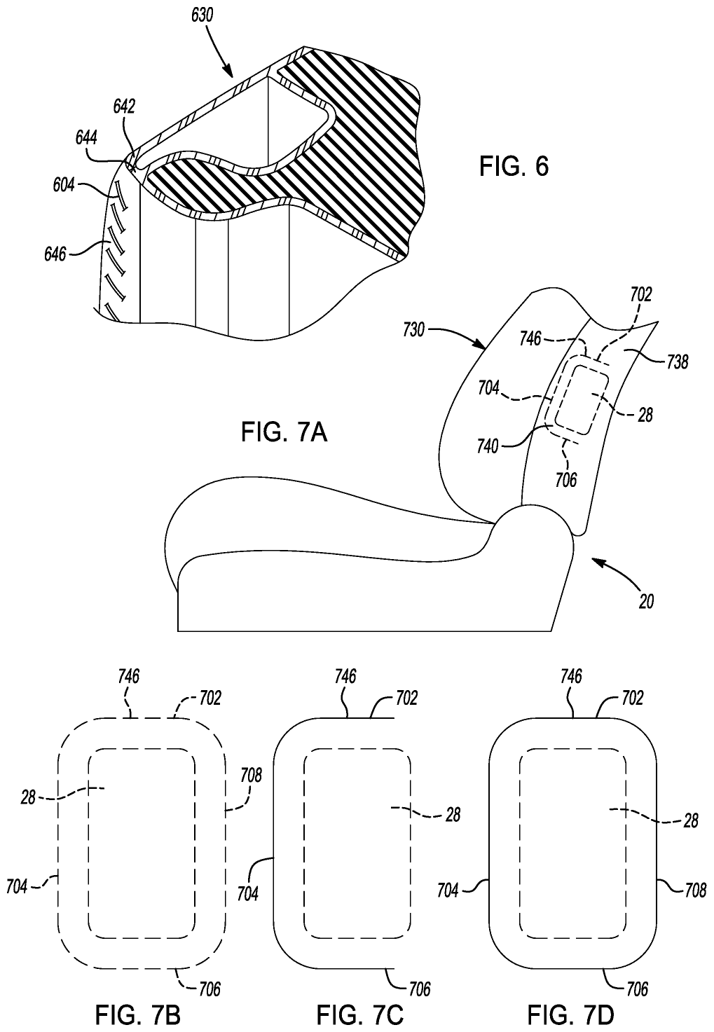

In another example, as shown in FIG. 6, a dissolving thread (or yarn) 604 is knit into the seat trim cover 630. The dissolving thread 604 performs a function similar to the temporary thread 504 previously described. The dissolving thread 604 can reinforce the deployment zone 646 between the first edge 642 and the second edge 644. In this position, the dissolving thread 604 prevents the first edge 642 from prematurely separating from the second edge 644.

The dissolving thread 604 can be made of any suitable material that can dissolve or is otherwise soluble in a processing agent that will not damage the seat trim cover 630. In the example shown, the dissolving thread 604 is made of a multi-filament polyvinyl alcohol (PVA) that is easily dissolvable in hot water. As such, the dissolving thread 604 can be dissolved after the seat trim cover 630 is installed on the vehicle seat 20 by steaming the seat trim cover 630.

FIG. 7A shows yet another example knitted seat trim cover 730. In this example, the seat trim cover 730 includes a deployment zone 746 that wraps around two or more sides of the airbag assembly 28. In this configuration, the second panel 740 is a flap of knitted material that separates from the first panel 738 when the airbag cushion 34 inflates to the deployed position. In the example of FIG. 7A, the deployment zone 746 includes a first side 702, a second side 704 and a third side 706. The first side 702, the second side 704 and the third side 706 separates from the first panel 738 when the airbag cushion 34 deploys. In other examples (see FIGS. 7B and 7D), the deployment zone 746 includes a fourth side 708 in addition to the first side 702, the second side 704 and the third side 706. In such four-sided examples, the second panel 740 can completely separate from the first panel 738. The second panel 740 operates as a releasable door that can completely separate from the first panel 738 when the airbag cushion 34 deploys.

As further shown in FIGS. 7A-D, the deployment zone 746 can be intermittently or continuously constructed of the weakened knitted structure previously described. The weakened knitted structure can have any of the structures previously described and can be designed to break, rip or otherwise fail at or above the predetermined deployment force threshold. In another example (not shown), the deployment zone 746 can include only the second side 704 and the third side 706. Alternatively, the deployment zone 746 can include only the second side 704. In addition, the deployment zone 746 can include one or more of the temporary connectors (e.g. temporary thread 504 and/or dissolving thread 604) to prevent a premature failure of the weakened knitted structure at the deployment zone 746.

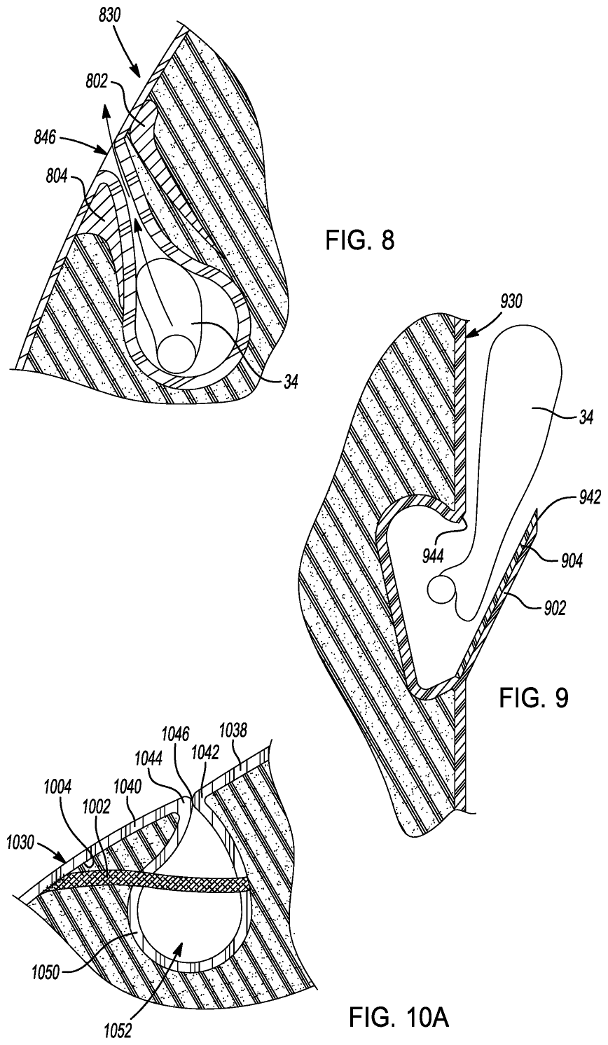

Referring now to FIG. 8, a knitted seat trim cover 830 includes a first deployment guide 802 and a second deployment guide 804. The first and second deployment guides 802, 804 are ramp-shaped members positioned adjacent to the deployment path of the airbag cushion 34. When the airbag cushion 34 inflates, the first and second deployment guides 802, 804 guide the airbag cushion 34 in a predetermined direction through the deployment zone 846. In this example, the first deployment guide 802 is positioned on a first side of the deployment zone 846 and the second deployment guide 804 is positioned on an opposite side of the deployment zone 846.

The first and second deployment guides 802, 804 are integrally knit into the seat trim cover 830 such that secondary processing is not required to form the first deployment guide 802 or the second deployment guide 804. The first and second deployment guides 802, 804 are relatively more rigid than the surrounding portions of the seat trim cover 830. The first and second deployment guides 802, 804 can be knit with a different yarn than the surrounding portions of the seat trim cover 830. For example, the first and second deployment guides 802, 804 (or portions thereof) are knit with a stiff monofilament yarn or a poly-praraphenylene terephthalamide-based yarn. In another example, the first and/or second deployment guide 802, 804 are knit from a heat-activated yarn. In this example, the seat trim cover 830 is heated above a predetermined temperature for a predetermined time period such that the heat-activated yarn melts and bonds with surrounding threads. In yet another example, the first and second deployment guides 802, 804 can be knit in at least one of a thicker and a denser knit pattern or structure. In this manner, the first and/or second deployment guides 802, 804 are more rigid than surrounding portions of the seat trim cover 830.

As explained above, the seat trim cover 830, in this example, includes two separate deployment guides 802, 804. In other examples, the seat trim cover 830 can include a single deployment guide that has a funnel or tube shape that can be positioned around the deployment zone 846. Since the deployment guides 802, 804 are integrally knitted into the seat trim cover 830, the deployment guides can have various shapes and configurations in order to guide the airbag cushion 34 in any number of predetermined directions. It is desirable to guide the airbag cushion 34 in a predetermined direction so that the inflated airbag cushion 34 deploys (usually outside the seat trim) and is positioned between an occupant and an interior component of the vehicle.

As shown in FIG. 9, the knitted seat trim cover 930, in this example, includes a flap 902 that flexes away from its initial position before the airbag cushion 34 inflates to the deployed position. The flap 902 can have various shapes including the shapes shown in FIGS. 7A and 7C. The flap 902, in the example shown, includes a reinforced portion 904 that is integrally knitted into the flap 902. The reinforced portion 904 makes the flap 902 stiffer than the surrounding portions of knitted seat trim cover 930. The flap 902 with the reinforced portion 904 guides the airbag cushion 34 to deploy in a predetermined direction. In the example shown, the flap 902 guides the deployment of the airbag cushion 34 in a direction upwards. The flap 902 is adjacent weakened first edge 942 and second edge 944 which open upon deployment.

The reinforced portion 904 is integrally knit into the seat trim cover 930 using a suitable yarn with a material that causes the reinforced portion 904 to be stiffer than surrounding portions of the knitted seat trim cover 930. For example, the reinforced portion 904 (or portions thereof) is knit with a stiff monofilament yarn or a poly-paraphenylene terephthalamide-based yarn. In another example, the reinforced portion 904 is knit from a heat-activated yarn. In yet other examples, the reinforced portion 904 can be constructed in any of the manners previously described for deployment guides 802, 804.

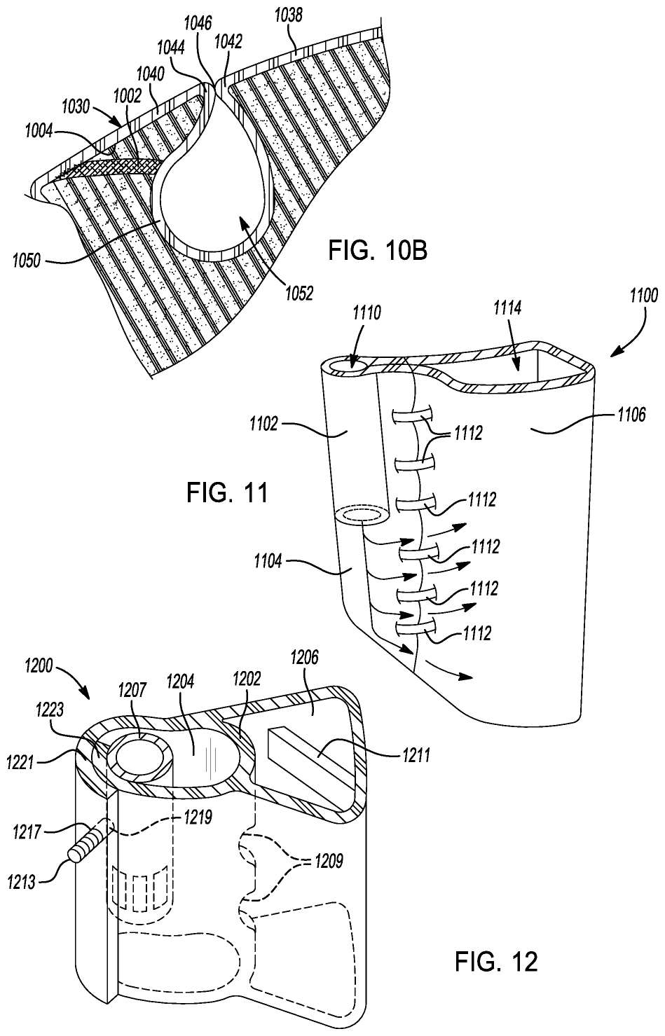

Referring now to FIGS. 10A and 10B, a seat trim cover 1030 includes a structure similar to that previously described. The seat trim cover 1030 includes a first panel 1038 and a second panel 1040. The first edge 1042 of the first panel 1038 and the second edge 1044 of the second panel 1040 are positioned adjacent to one another at the deployment zone 1046. The pocket panel 1050 defines the airbag pocket 1052 in which one or more elements of an airbag assembly (not shown) is positioned. In the examples shown, the seat trim cover 1030 also includes a tether 1002. The tether 1002 is integrally knit in the seat trim cover 1030 such that secondary processing is not required to connect the tether 1002 to the seat trim cover 1030.

In the example shown in FIG. 10A, the tether 1002 extends from an inner side 1004 of the second panel 1040 across the airbag pocket 1052 to a side of the pocket panel 1050 located opposite to the first panel 1038. The tether 1002 would be located adjacent to an airbag assembly (not shown). As shown in FIG. 10B, the tether 1002, in this example, extends from the inner side 1004 of the second panel 1040 to a side of the pocket panel 1050 located opposite to the second panel 1040. The tether 1002 restricts movement of the airbag pocket 1052 during deployment of the airbag cushion 34. In such a manner, the tether 1002 is used to guide the direction or path of deployment of the airbag cushion 34 in a predetermined direction. In other examples, the seat trim cover 1030 can include tethers having other sizes, positions and attachment locations to restrict movement and guide the deployment of the airbag cushion 34.

In addition to or in combination with the seat trim covers of the present disclosure, an airbag cushion 1100, such as the example shown in FIG. 11, is made of a knitted material. As such, the aforementioned knitting processes are used to create shapes, features and elements that would otherwise require secondary processing to attach to traditional airbag cushions. The airbag cushion 1100 includes a chute 1102, a plenum portion 1104 and an inflation portion 1106. The chute 1102 defines an inflation gas channel 1110 that causes inflation gas to flow from an inflator (not shown) located in the chute 1102 or remote from the chute 1102 to the inflation portion 1106. The chute 1102 can be clamped to the inflator using a clamp (not shown) or the chute 1102 can be folded around the inflator with holes through which inflator studs protrude. In this manner, the inflator can be attached to the chute 1102. In the example shown, the chute 1102 is cylindrical shape. In other examples, the chute 1102 can have other shapes or profiles to guide the inflation gas in a desired path.

The plenum portion 1104 is a portion of the airbag cushion 1100 through which the inflation gas is distributed into the inflation portion 1106. In the example shown, the plenum portion 1104 includes one or more optional dividers 1112 that separate the plenum portion 1104 into two or more pathways through which the inflation gas can flow into the inflation portion 1106. As shown, the plenum portion 1104 causes inflation gas to flow from the exit of the chute 1102 between the dividers 1112 and into the inflation portion 1106. The dividers 1112, in the example shown, are solid or semi-solid regions of the airbag cushion 1100. The dividers 1112 can be knit into the structure of the airbag cushion 1100 during the knitting process. The dividers 1112 can include heat-activated yarn material that melts when heated to create the solid or semi-solid regions in the airbag cushion 1100.

The inflation portion 1106 is a panel of material in the airbag cushion 1100 that defines a chamber 1114 that fills with the inflation gas that flows from the chute 1102 and through the plenum portion 1104. As can be appreciated, while shown in as a sectional illustration in FIG. 11, the chamber 1114 of the inflation portion 1106 is a closed volume that can fill with the inflation gas. The inflation portion 1106 can include knit tethers to define the inflated volume or knit panels to direct the gas flow within the inflation portion 1106.

It is desirable to control the flow of the inflation gas from the inflator of the airbag assembly and into the inflation portion 1106 of the airbag cushion 1100 to control the rate of deployment of the airbag cushion 1100 and the direction of deployment of the airbag cushion 1100. For example, it may be desirable to fill the bottom section of the airbag cushion 1100 (as shown in FIG. 11) first and then to cause the top portion of the airbag cushion 1100 to fill in order that the airbag cushion 1100 is advantageously positioned between an occupant and an internal component of the vehicle. The chute 1102, the plenum portion 1104 and the inflation portion 1106 are oriented accordingly to cause the airbag cushion 1100 to deploy in a desired position and in a desired direction.

The chute 1102, the plenum portion 1104 and the inflation portion 1106 are integrally knit with the airbag cushion 1100. In this manner, the need for secondary processing of the airbag cushion 1100 is reduced and/or minimized. The chute 1102, the plenum portion 1104 and/or the inflation portion 1106 can be made with different types of yarns in order to result in the structure of the airbag cushion 1100 as shown. In this example, the chute 1102 and the dividers 1112 are knit with a higher strength and more heat resistant yarn that enables the chute 1102 and the dividers 1112 to maintain their shapes and integrity when the airbag cushion 1100 inflates to the deployed position. The use of a more dense knit pattern in the chute 1102 and/or the dividers 1112 can cause the chute 1102 and/or the dividers 1112 to be less porous than the surrounding knitted portions of the airbag cushion 1100. In this manner, the inflation gases are less likely to pass through the chute 1102 and/or the dividers 1112 and instead, are guided into the inflation portion 1106 as previously described. In another example, heat-activated yarns can be used in the knitted structure of the one or more dividers as the heat from the inflator can rupture these dividers 1112 and the small delay in this rupture could be used as a way to control the gas flow in the airbag cushion 1100. Since the heat generated during inflator deployment can heat and unfuse any fused material that may be present in the airbag cushion due to the use of heat-activated yarns, such heat activated yarns may not be used in regions of the airbag cushion 1100 in which the integrity of the airbag cushion 1100 needs to be maintained.

FIG. 12 shows another example knitted airbag cushion 1200. The airbag cushion 1200, in this example, has a different construction when compared to the airbag cushion 1100 previously described. The airbag cushion 1200 includes a chute 1202, a plenum portion 1204 and an inflation portion 1206. The inflation portion 1206 is similar to the inflation portion 1106 in most respects. The chute 1202 and the plenum portion 1204, in this example, is a region of relatively rigid knitted material that maintains integrity when the inflator 1207 is deployed. The plenum portion 1204 is used to guide inflator gas into the inflation portion 1206 via one or more gas passages 1209. The inflation portion 1206 can contain one or more knit tethers 1211. The inflator 1207 can be attached via a stud 1213 that projects through holes 1217, 1219 in corresponding flaps 1221, 1223 in the chute portion 1202. In other examples, more than two flaps 1221, 1223 can be used.

The plenum portion 1204 and/or the chute 1202 is made, or at least partly made, of a different yarn material than surrounding portions of the airbag cushion 1200. In one example, the plenum portion 1204 is knit with a stiff monofilament yarn or a poly-paraphenylene terephthalamide-based yarn. In another example, the plenum portion 1204 is knit using a denser knit pattern. In other examples, other suitable yarn types can be used.

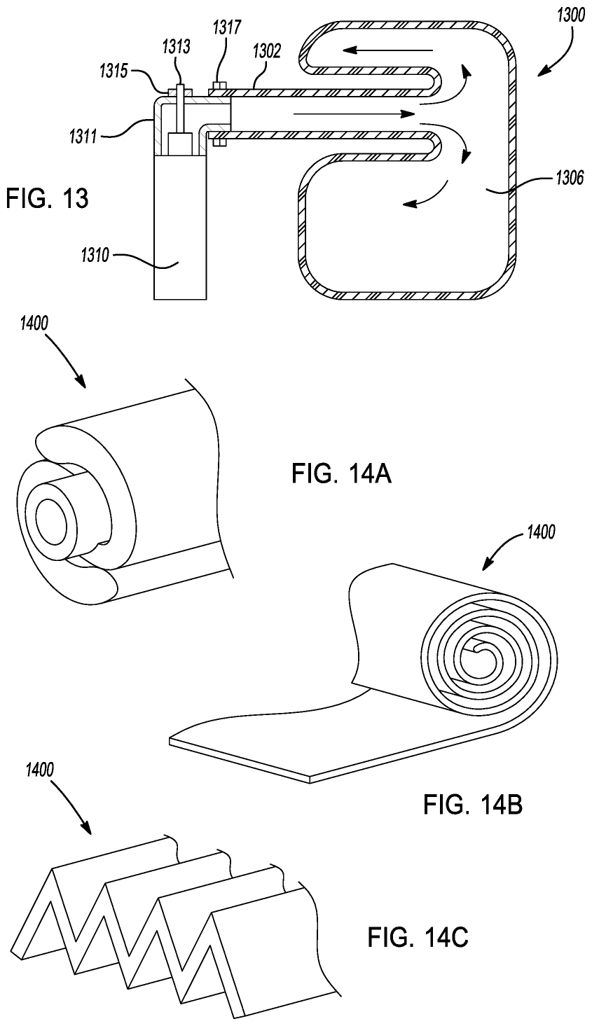

Referring now to FIG. 13, another example airbag cushion 1300 is shown. In this example, the airbag cushion 1300 includes a chute 1302 and an inflation portion 1306. The chute 1302 is positioned in a center region of the airbag cushion 1300 such that the inflation portion 1306 is located on both sides of the chute 1302. In this configuration, the inflation gas that exits the inflator 1310 flows into a region of the inflation portion 1306 above the chute 1302 and a region of the inflation portion 1306 below the chute 1302 when the inflation gas leaves the chute 1302. It may be desirable to knit the airbag cushion 1300 in such a tube-in-tube configuration so that multiple regions of the inflation portion 1306 are filled with gas simultaneously. As also shown, the inflator 1310 is attached to a gas guide 1311 via a stud 1313 and a nut 1315. Gas guide 1311 is attached to chute 1302 via a clamp 1317.

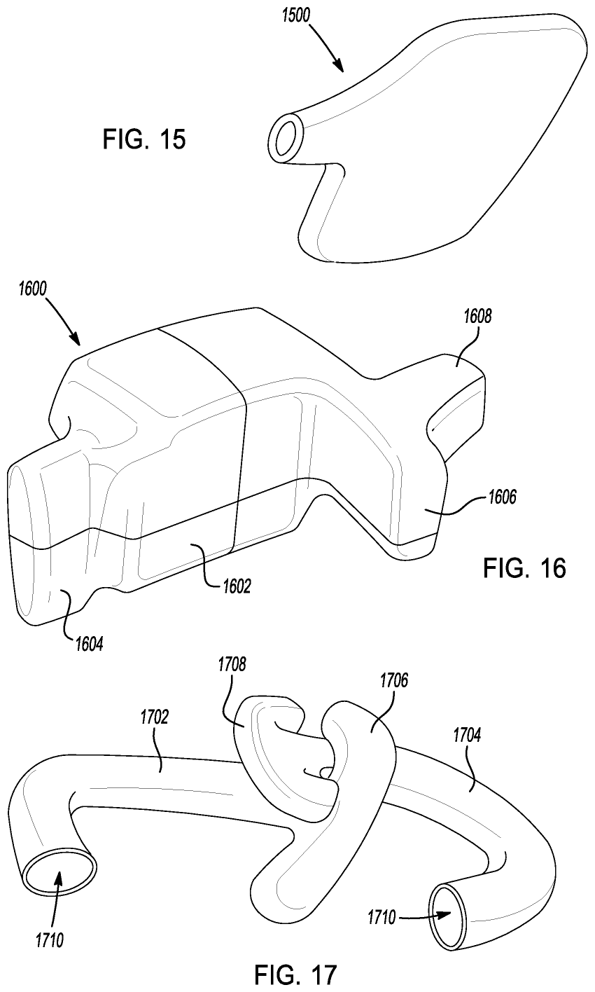

Referring now to FIG. 14A, an airbag cushion 1400 is knit with a suitable structure to cause the airbag cushion 1400 to fold, roll or otherwise compress into a stowed position as shown. In the stowed position, the airbag cushion 1400 occupies a smaller volume than when in the deployed position (see FIG. 15) since the airbag cushion 1400 is not filled with the inflation gas. In the stowed position, the airbag cushion 1400 can be inserted into the airbag pockets of the seat trim cover panels previously described. In other applications, the airbag cushion 1400 can be stowed with the airbag assembly as needed.

The airbag cushion 1400, in the example shown, is knit with a common stitch pattern in the same direction. Such knitted structure of the airbag cushion 1400 causes the panels of knitted material to roll as shown in FIG. 14B. In other examples, the airbag cushion 1400 can be knit to create creases and/or predisposed folding hinges that cause the knitted material to fold or compress into a stowed position unless filled with an inflation gas. Such knitted structure can include a zig-zag folded pattern or accordion pattern as shown in FIG. 14C. In other examples, other suitable folding or creased patterns can be used.

The knitted structure of the airbag cushion 1400 reduces or minimizes the time required to fold the airbag cushion into the stowed position during assembly. To further assist in this regard, temporary, melting, or dissolvable threads are knit into the airbag cushion 1400 to maintain the airbag cushion 1400 in the stowed position. The temporary, melting or dissolvable threads are removed, heated or dissolved after assembly prior to deployment of the airbag cushion 1400. In other examples, the temporary, melting or dissolvable threads can be melted or otherwise fractured by the gas pressure and heat generated by the inflator during the deployment of the airbag cushion 1400.

The airbag cushions of the present disclosure can be knit to have a desired shape or profile. As shown in FIG. 15, an airbag cushion 1500 has a simple shape. As shown in FIG. 16, an airbag cushion 1600 is integrally knit to have a shape with one or more projecting chambers. The airbag cushion 1600 includes a main chamber 1602, a first side chamber 1604, a second side chamber 1606 and a projecting chamber 1608. The main chamber 1602, the first side chamber 1604, the second side chamber 1606 and the projecting chamber 1608 are integrally knit together such that secondary joining or other processes are reduced or minimized.

The airbag cushion 1600, or other example airbag cushions, can be knit to include interlocking arms or other shapes. For example, the airbag cushions are knit to include a first arm 1702 and a second arm 1704. The first arm 1702 includes a first connector bar 1706 and the second arm 1704 includes a second connector bar 1708. The first connector bar 1706 and the second connector bar 1708 have an interlocking shape such as a dog bone shape or fish hook shape that curves back toward the first arm 1702 and the second arm 1704, respectively. The first arm 1702 and the second arm 1704 have similar rounded cross-sectional shapes and the first connector bar 1706 and the second connector bar 1708 are oriented approximately at 90 degrees to one another. In this configuration, the first connector bar 1706 and the second connector bar 1708 grip one another when the first connector bar 1706 contacts the second connector bar 1708.

As can be appreciated, the first arm 1702 and the second arm 1704 are positioned on an airbag cushion and extend therefrom when the airbag cushion inflates to a deployed position. The first arm 1702 and the second arm 1704 are used to wrap around and releasably connect the airbag cushion around an occupant or around an internal component in a vehicle. In the connected position, the first arm 1702 and the second arm 1704 maintain the airbag cushion in a desired position or desired orientation. Alternatively, the first arm 1702 is knit into a first airbag cushion and the second arm 1704 is knit into a second airbag cushion. The first arm 1702 and the second arm 1704, in such a configuration, are used to wrap an occupant or an internal component of the vehicle. The first arm 1702 and the second arm 1704 can be knit with a suitable structure such that the first arm 1702 extends and curls in a first direction and the second arm 1704 extends and curls in a second direction. The first and second directions of the first arm 1702 and the second arm 1704, respectively, are different from one another. In the example shown, the first arm 1702 curls in a direction opposite to the direction of curl of the second arm 1704. In such a manner, the first arm 1702 and the second arm 1704 can curl toward one another to interlock as previously described.

As shown in FIG. 17, the first arm 1702 and the second arm 1704 can be knit to be hollow with a central chamber 1710. The central chamber 1710 fills with inflation gas when the airbag cushion inflates, causing the first arm 1702 and the second arm 1704 to extend in a desired direction. In other examples, the first arm 1702 and/or the second arm 1704 are knit with yarn materials that cause the first arm 1702 and the second arm 1704 to be relatively more rigid than the knitted airbag cushion to which the first arm 1702 and the second arm 1704 are attached. In one example, the first arm 1702 and the second arm 1704 are knit with a stiff monofilament yarn or a poly-paraphenylene terephthalamide-based yarn. In another example, the first arm 1702 and the second arm 1704 are knit from a heat-activated yarn. In yet another example, the first arm 1702 and the second arm 1704 are knit using a denser knit pattern.

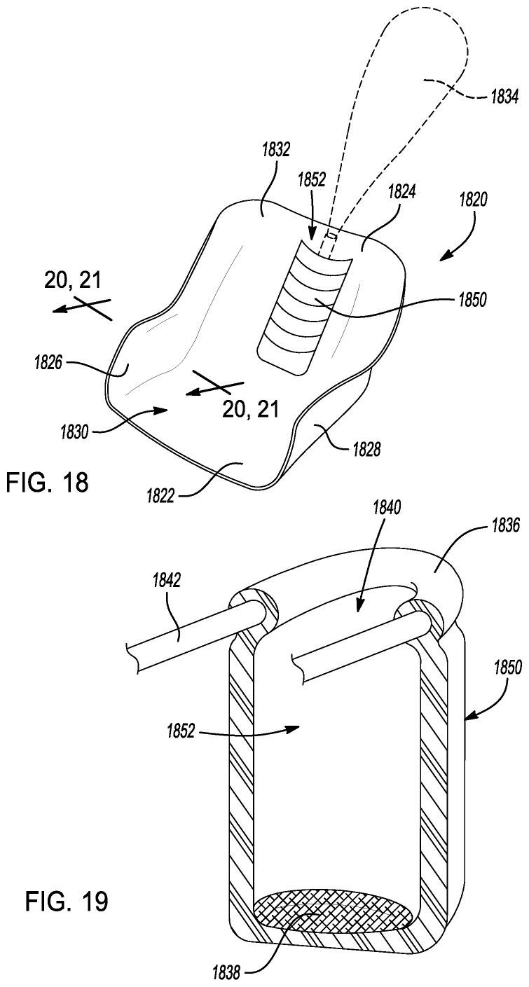

Referring now to FIG. 18, another example vehicle seat 1820 is shown. In this example, the vehicle seat 1820 includes a seat bottom 1822, a seat back 1824, a first side wall 1826 and a second seat side wall 1828. A knitted seat trim cover 1830 is installed over the internal structure of the vehicle seat 1820. The knitted seat trim cover 1830 includes a cover panel 1832 and a pocket panel 1850. The cover panel 1832 and the pocket panel 1850 are integrally knit together such that secondary processes, such as sewing the pocket panel 1850 to the cover panel 1832, is reduced or minimized.

In the example shown, the pocket panel 1850 is positioned on an occupant-facing side of the seat trim cover 1830 on the seat back 1824. An airbag assembly can be positioned in the vehicle seat 1820 with, at least, an airbag cushion 1834 positioned inside an airbag pocket 1852 defined by the pocket panel 1850. As further described below, the airbag cushion 1834 inflates to the deployed position in which the airbag cushion 1834 projects upward from the airbag pocket 1852.

As shown in FIG. 19, the pocket panel 1850 includes a deployment edge 1836 and a base 1838. The deployment edge 1836 defines an airbag opening 1840 through which the airbag cushion 1834 inflates when deployed. The deployment edge 1836 includes a cinch cord 1842 that extends through a pathway in the deployment edge 1836. When tension is applied to the cinch cord 1842, the cinch cord 1842 causes the airbag opening 1840 to close. When tension is released from the cinch cord 1842, the deployment edge 1836 can separate from the cover panel 1832 and allow the airbag cushion 1834 to inflate to the deployed position through the airbag opening 1840.

In other examples, the deployment edge 1836 is joined to the cover panel 1832 during the knitting process. The deployment edge 1836, in such examples, includes a weakened knitted structure, as previous described, that breaks, rips or tears when impacted by the airbag cushion 1834 during inflation. This weakened knitted structure can be the cinch cord 1842.

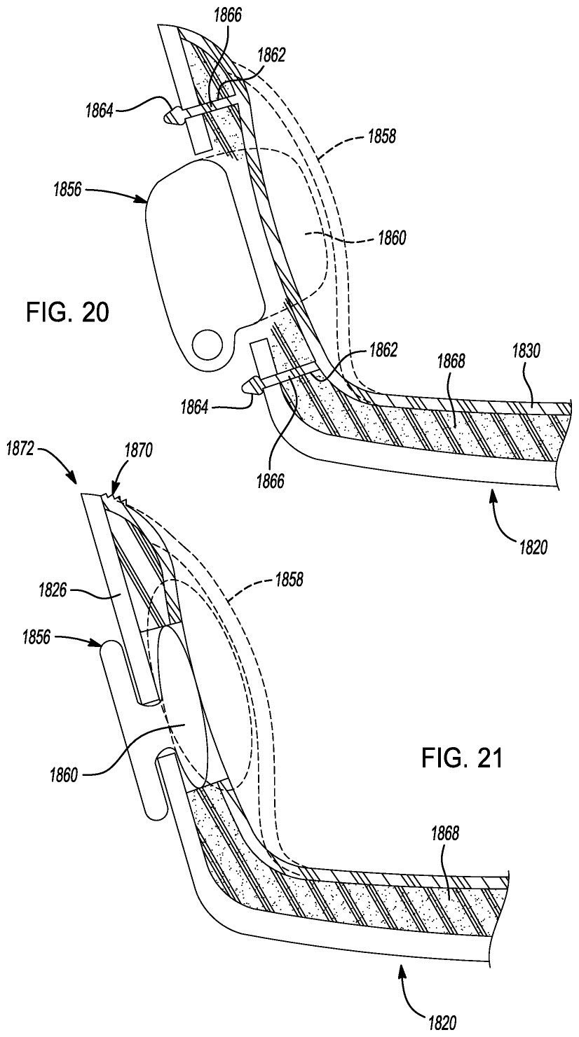

In the example shown in FIG. 20, the vehicle seat 1820 includes a side wall airbag assembly 1856. The side wall airbag assembly 1856 is positioned behind an occupant-facing surface 1858 of the seat trim cover 1830. In this example, an airbag cushion 1860 inflates to a deployed position (shown with dashed lines) and remains behind the expanded occupant-facing surface 1858 of the seat trim cover 1830. When this occurs, the occupant-facing surface 1858 of the seat trim cover 1830 bulges (as shown in dashed lines) or expands into the vehicle seat 1820. In such a position, the inflated airbag cushion 1860 (as shown in dashed lines) presses the occupant-facing surface 1858 of the seat trim cover 1830 into an occupant's hips or pelvis if an occupant is seated in the vehicle seat 1820 when the airbag cushion 1860 inflates.

As further shown, the seat trim cover 1830 includes one or more knitted fasteners 1862. The knitted fastener 1862 includes a head 1864 and a shaft 1866. The head 1864 of the knitted fastener 1862 is inserted into an opening in the vehicle seat 1820 to hold the seat trim cover 1830 in position relative to a foam support 1868 of the vehicle seat 1820. When the airbag cushion 1860 inflates, the airbag cushion 1860 exerts a force on the seat trim cover 1830 and causes the knitted fasteners 1862 to be pulled out of the foam support 1868. When the knitted fasteners 1862 are no longer engaged to the foam support 1868, the seat trim cover 1830 can move away from the foam support 1868 and expand in the direction as shown.

The knitted fasteners 1862 have sufficient rigidity to retain the seat trim cover 1830 on the vehicle seat 1820. In one example, the knitted fasteners 1862 are knit with a heat-activated yarn. After being heated, the heat-activated yarn melts and bonds with surrounding threads. After cooling, the knitted fasteners 1862 have the defined head 1864 and the shaft 1866 of sufficient rigidity. In another example, the knitted fasteners 1862 use a stiffer material. In yet another example, the knitted fasteners 1862 use a denser knit construction.

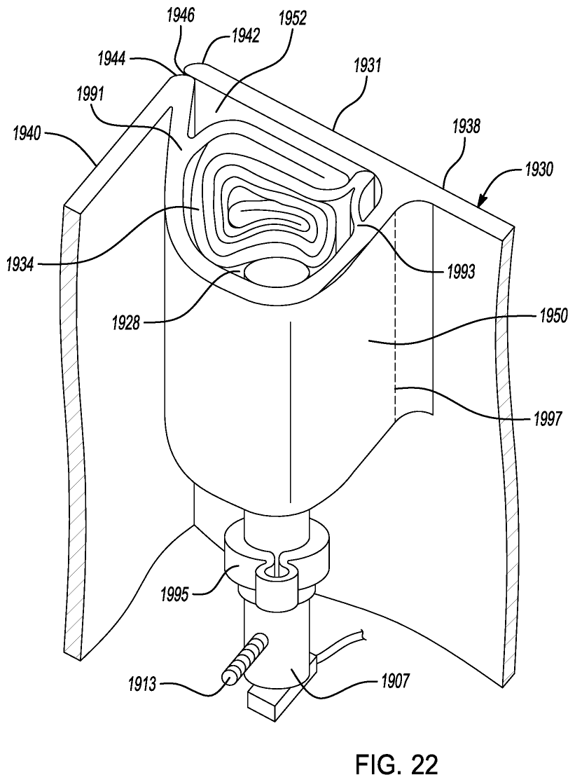

FIG. 22 shows a dynamic section of a portion of a knitted seat trim cover 1930. The seat trim cover 1930 includes the first panel 1938, the second panel 1940 and a pocket panel 1950. The pocket panel 1950 and the first panel 1938 share a common material thickness as marked as shared region 1931. Shared region 1931 includes the first edge 1942 and the second panel 1940 includes the second edge 1944. The pocket panel 1950 is a portion of the seat trim cover 1930 that extends between the first edge 1942 and the second edge 1944 while sharing the shared region 1931 as previously described. As shown, the pocket panel 1950 defines an airbag pocket 1952. The airbag pocket 1952 is a cavity that holds one or more elements of the airbag assembly 1928. In this example, the airbag pocket 1952 has the airbag cushion 1934 integrally knit into the airbag pocket 1952 via a first interface 1991 and a second interface 1993. The airbag cushion 1934 extends out the bottom of the airbag pocket 1952 and clamp 1995 clamps inflator 1907 to the airbag cushion 1934. Inflator 1907 can include one or more studs 1913 to connect the assembly to a structure on a vehicle seat. While not shown, seat cushion foam can surround the airbag assembly 1928 and the airbag pocket 1952 at the otherwise unsupported regions inside the seat trim cover 1930.

The first edge 1942 and the second edge 1944 can separate upon deployment of the airbag cushion 1934. In such an example, the airbag cushion 1934 can expand outside the seat trim cover 1930 through the deployment zone 1946. In other examples, the joint between the first edge 1942 and the second edge 1944 can be strong to resist the forces caused by the deployment of the airbag cushion 1934. Instead, the airbag pocket 1952 can be designed to have a weakened region 1997. In examples with a weakened region 1997, the airbag cushion 1934 can inflate under the seat trim 1930.

Another example seat trim cover 1830 is shown in FIG. 21. In this example, the seat trim cover 1830 includes an expansion zone or weakened knitted structure that permits the occupant-facing surface 1858 of the seat trim cover 1830 to expand (as shown in dashed lines) when the airbag cushion 1834 inflates to the deployed position (as shown in the dashed lines). The expansion zone 1870, in this example, is positioned at an armrest area 1872 of the vehicle seat 1820. In other examples, the expansion zone 1870 is positioned at other locations on the vehicle seat 1820.

The expansion zone 1870 is knit with an elastic yarn and/or a yarn with high elongation that permits the seat trim cover 1830 to expand at the expansion zone 1870. As the airbag cushion 1834 inflates to the deployed position, the seat trim cover 1830 moves in a direction away from the first side wall 1826. As this occurs, the expansion zone 1870 stretches to allow the seat trim cover 1830 to move as described.

In other examples, the seat trim cover 1830 can include a weakened knitted structure at the expansion zone 1870. In such examples, the seat trim cover 1830 breaks, tears or separates at the expansion zone 1870. The weakened knitted structure at the expansion zone 1870 can have any suitable weakened structure such as those previously described.

The knitted seat trim covers of the present disclosure can combine one or more of the previously described examples and incorporate them into a single knitted assembly. For example, a knitted seat cover assembly can include a knitted seat trim cover combined with a knitted deployment guide, a knitted airbag tether and a knitted airbag cushion. Such a knitted seat cover assembly is integrally knitted during the same knitting process. Other elements related to knitted components described herein can also be integrated into the knitted seat trim covers.

In another example, wiring elements, such as, power wires, control wires and the like are knit into the knitted seat trim cover. Such an integrated knitted seat trim cover reduces or minimizes the need to assemble wiring harnesses in vehicle seats or in airbag assemblies.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between layers, assembly components, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A knitted seat trim cover for use on a vehicle seat equipped with an airbag assembly, the knitted seat trim cover comprising:
a first knitted panel including a first edge;
a second knitted panel including a second edge, the first edge positioned adjacent the second edge to define an airbag deployment zone; and
a pocket panel integrally knit with the first knitted panel and the second knitted panel, the pocket panel defining an airbag pocket configured to hold at least a portion of the airbag assembly.

2. The knitted seat trim cover of claim 1, wherein:
the airbag pocket is configured to hold an airbag cushion; and
the first edge and the second edge separate to permit the airbag cushion to move from the airbag pocket through the airbag deployment zone between the first edge and the second edge.

3. The knitted seat trim cover of claim 1, wherein the first edge and the second edge are releasably connected to each other at the airbag deployment zone.

4. The knitted seat trim cover of claim 3, wherein the first edge and the second edge are connected with one or more loops of connecting yarn material at the airbag deployment zone, the one or more loops of connecting yarn material configured to break to permit the first edge and the second edge to separate to allow an inflated airbag to pass between the first edge and the second edge.

5. The knitted seat trim cover of claim 4, wherein the first panel and the second panel are knitted of a different material than the connecting yarn material in material type or knit density.

6. The knitted seat trim cover of claim 2, wherein the first edge and the second edge are connected to one another with a temporary thread, the temporary thread configured to maintain the first edge adjacent to the second edge while the knitted seat trim cover is installed on a vehicle seat and to dissolve after the knitted seat trim cover is installed to permit the first edge to separate from the second edge when the airbag cushion moves through the airbag deployment zone.

7. The knitted seat trim cover of claim 2, wherein the pocket panel includes a first knitted deployment guide configured to guide the airbag cushion in a predetermined direction through the airbag deployment zone.

8. The knitted seat trim cover of claim 7, wherein the first knitted deployment guide is knitted of one of a heat-activated yarn material, a material stiffer than a material of the first panel, and a knitted pattern more dense than a knitted pattern of the first panel.

9. The knitted seat trim cover of claim 8, wherein the pocket panel includes a second knitted deployment guide positioned on a side of the airbag deployment zone opposite to the first knitted deployment guide.

10. The knitted seat trim cover of claim 2, wherein the first panel includes a knitted deployment guide configured to guide the airbag cushion in a predetermined direction when the airbag cushion inflates to a deployed position, and the knitted deployment guide is knitted of at least one of a heat-activated yarn material, a material stiffer than a material of the first panel surrounding the deployment guide, and a knitted pattern more dense than a knitted pattern of the first panel surrounding the deployment guide.

11. The knitted seat trim cover of claim 1, further comprising a knitted airbag cushion positioned inside the airbag pocket.

12. The knitted seat trim cover of claim 11, wherein the airbag cushion includes a knitted chute that defines an inflation pathway to direct inflation gas in a predetermined direction, the knitted chute integrally knitted into the airbag cushion.

13. The knitted seat trim cover of claim 11, wherein the airbag cushion includes a knitted plenum portion, the knitted plenum portion configured to distribute inflation gas in the airbag cushion to cause the airbag cushion to inflate in a predetermined direction.

14. The knitted seat trim cover of claim 11, wherein the airbag cushion or the pocket panel includes one or more tethers integrally knit with the seat trim cover, the one or more tethers configured to guide deployment of the airbag cushion in a predetermined direction.

15. The knitted seat trim cover of claim 11, wherein the airbag cushion is knitted into the pocket panel.

16. The knitted seat trim cover of claim 11, wherein the airbag cushion is knit with a knitted structure that causes the airbag cushion to roll or fold until the airbag cushion is inflated.

17. The knitted seat trim cover of claim 11, wherein the airbag cushion includes a first arm and a second arm that project outward from an inflation portion of the airbag cushion, the first arm configured to interlock with the second arm to maintain the airbag cushion in a predetermined position.

18. A knitted seat trim cover for use on a vehicle seat, the knitted seat trim cover comprising:
a cover panel configured to cover a seating surface of the vehicle seat; and
an airbag pocket integrally knit with the cover panel, the airbag pocket including an expansion portion configured to elongate or expand; and
an airbag cushion positioned inside the airbag pocket, the airbag cushion configured to expand the airbag pocket when the airbag cushion inflates to a deployed position.

19. The knitted seat trim cover of claim 18, wherein the airbag pocket includes a deployment edge configured upon deployment to define an opening through which the airbag cushion inflates to the deployed position.

20. The knitted seat trim cover of claim 18, wherein the airbag cushion is positioned behind an occupant-facing surface of the cover panel in both a stowed position and the deployed position, the airbag cushion causing the occupant-facing surface to expand toward an occupant when the airbag cushion inflates to the deployed position.
